(19) United States
(12) Patent Application Publication
(10) Pub. No.: US 2024/0020551 A1
(43) Pub. Date: Jan. 18, 2024

(54) SYSTEMS AND METHODS FOR EMOTIONAL AUGMENTATION OF EMOTIONLESS SOFTWARE BY INFERENCE FROM USER EMOTIONS

(71) Applicants: Mark Changizi, Columbus, OH (US); Timothy P. Barber, Miami Beach, FL (US)

(72) Inventors: Mark Changizi, Columbus, OH (US); Timothy P. Barber, Miami Beach, FL (US)

(21) Appl. No.: 17/866,405

(22) Filed: Jul. 15, 2022

(51) Int. Cl. G06N 5/04

(52) U.S. Cl. CPC G06N 5/04

(57) ABSTRACT

Systems and methods for emotional augmentation of emotionless software by inference from user emotions comprise initiating a call with a participant in communication with a communication module of the computer. A first communication is received by the computer from the participant, the first communication comprising an emotion attribute comprising information about an emotional characteristic expressed by the participant. Additionally, evaluating, by the computer, the emotion attribute expressed by the participant from the first communication. An emotion feedback attribute is generated based on the emotion attribute to elicit a response from the participant. A second communication is output comprising the emotional expression attribute.

### TECHNICAL FIELD

The present disclosure relates to processes for acquisition of input data regarding an emotional state of a user of an emotionless software application and modulation of an output of the emotionless software application based upon the input data.

### BACKGROUND

A great many software applications and devices (such as, for example, so-called “smart devices”) are designed to interact with a human user, for example by outputting information to the user and receiving information from the user in an exchange that is more or less conversational. For example, such output and input may take the form of visual, audio, keyboard entry, haptic and/or other forms of expression, to list just a few examples. Such software applications normally have not in any way been designed to have or to express human emotion. As such, these software applications do not possess the ability to augment the user experience with emotional expressions that would be recognizable to the human user. In view of the above, there is a need for processes for acquisition of input data regarding an emotional state of a user of an emotionless software application and modulation of an output of the emotionless software application based upon the input data. If novel processes could be found for the acquisition of input data regarding an emotional state of a user of an emotionless software application and the modulation of an output of the emotionless software application based upon the input data, it would represent a useful contribution to the art.

### SUMMARY OF THE INVENTION

According to some embodiments, systems and methods for emotional augmentation of emotionless software by inference from user emotions are provided. Input data is assessed by a computer regarding an emotional state of a user of an emotionless software application. According to some embodiments, an output of the emotionless software application is modulated based upon the input data.

The disclosed systems and methods include initiating, by a computer, a call with a participant in communication with a communication module of the computer. A first communication is received by the computer from the participant, the first communication comprising an emotion attribute comprising information about an emotional characteristic expressed by the participant. Additionally, evaluating, by the computer, the emotion attribute expressed by the participant from the first communication. An emotion feedback attribute is generated based on the emotion attribute to elicit a response from the participant. A second communication is output comprising the emotional expression attribute.

In some embodiments, an emotional expression attribute comprises one or more of: a satisfaction signal associated with the first communication and a want signal associated with the first signal. In some embodiments, determining an emotional characteristic can include determining, by the computer, a first score associated with a predictive level of certainty associated with the emotion attribute, and determining a second score associated with a price of disagreement, wherein the second score represents a metric of social capital associated with the emotional attribute.

In some embodiments, generating an emotion feedback attribute can include determining one or more intended personality traits, such as an active or passive personality trait.

In some embodiments, generating the emotion feedback attribute can include identifying a first set of emotion spaces associated with an emotion attribute of the participant, and identifying a second set of emotion spaces associated with an emotional expression attribute of the computer. Generating the emotion feedback attribute can further include identifying a relationship between the first set of emotion spaces and the second set of emotion spaces. According to some embodiments, perception information of the participant about an intended satisfaction signal can be assessed by the computer's emotional expression, based on the emotional characteristic expressed by the participant. In some embodiments, evaluating the emotion attribute can include identifying a set of emotion spaces associated with the perception information.

### BRIEF DESCRIPTION OF THE DRAWINGS

FIG. 1 depicts a system for emotional augmentation of emotionless software by inference from user emotions, according to some embodiments.

FIG. 2 depicts a system for emotional augmentation of emotionless software by inference from user emotions, according to some embodiments.

FIG. 3 depicts a system for emotional augmentation of emotionless software by inference from user emotions, according to some embodiments.

FIG. 4A depicts an emotion expression space for an acknowledgment signal, according to some embodiments.

FIG. 4B depicts an emotion expression space for a counter-response signal, according to some embodiments.

FIG. 5 depicts a relationship between two emotion expression spaces, according to some embodiments.

FIG. 6 depicts passive personalities dispositions in a system and method for emotional augmentation of emotionless software by inference from user emotions, according to some embodiments.

FIG. 7 depicts passive personalities temperaments in a system and method for emotional augmentation of emotionless software by inference from user emotions, according to some embodiments.

FIG. 8 depicts active personalities in a system and method for emotional augmentation of emotionless software by inference from user emotions, according to some embodiments.

FIG. 9 depicts passive counter-responses in a system and method for emotional augmentation of emotionless software by inference from user emotions, according to some embodiments.

FIGS. 10A and 10B depict active counter-responses in a system and method for emotional augmentation of emotionless software by inference from user emotions, according to some embodiments.

### DETAILED DESCRIPTION

Humans are extremely emotional animals and have evolved to be extremely adept at reading the emotional state of other humans into which they come into contact. As an example, consider a first human interacting with a second human by means of an audio exchange, such as a telephone call or other exchange of audio information (or an electronic text exchange, such as an email or chat session)—all of the above referred to herein as a “metaphorical call.” Neither of the humans can see facial expressions or body language of the other participant. Yet each is provided data about the emotional state of the other participant via clues from data such as the pitch, inflection, speed and/or volume, etc. of other participant's speech (for audio input), or the word choice, sentence structure, font effects (e.g., bold, italics, underline, font size), and/or capitalization, etc. of other participant's speech (for text-based input). Using this data about the emotional state of the other participant, a participant can modulate his/her output to create a desired perceived emotional expression to the other participant. It should be noted that such desired perceived emotional expression may reflect the actual emotional state of the participant, or may reflect a different emotional state that the participant wishes to project to elicit a desired reaction from the other participant. For example, the participant projecting the emotional expression may be involved in a negotiation with the other participant and may wish to influence the reaction of the other participant by projecting a desired perceived emotional expression that is different from the participant's actual current emotional expression.

By observing emotional expressions, an observer, such as a third party, can make a substantially accurate prediction about other (e.g., unseen, unheard, etc.) emotional expressions of a participant. Therefore, humans are able to reasonably reliably infer the emotions of the person on the other side of the metaphorical call, or at least the emotion that the participant on the other side of the metaphorical call wishes to project (e.g., “bluffing” during a poker game).

According to embodiments described herein, methods and systems are provided for automatically determining the emotions expressed on a first side of the metaphorical call, based on the expressions on a second side of the metaphorical call. One aspect of this is where the first side of the metaphorical call is a software application, not a human at all. By determining the emotions expressed on the first side of the metaphorical call, one is thereby determining what expressions the human (or even a second software application as well) on the second side of the metaphorical call probably attributes to the software application on the first side. Another aspect is that the software application itself can use the presently disclosed embodiments to determine what the human believes the software application's emotional expression was, and to use that information to modulate its behavior accordingly. This aspect provides an actual solution to the problem of giving machines emotional self-awareness.

When a user interacts with a machine (such as a software application that can include a two-dimensional avatar (for example, a human or non-human character displayed on a display such as a computer screen) or a physical avatar (for example, a human or non-human character rendered as a three-dimensional object)), even a machine not designed to have or express emotions, the user often nevertheless perceives (or anthropomorphizes) the machine to be expressing human emotions by virtue of the way the machine behaves in the interaction. This is true even if the designer of the machine had no intention of designing the machine to display any emotion whatsoever.

According to embodiments described herein, a method is disclosed for inferring the emotions on the other side of a metaphorical call, whether the metaphorical call is between a human and a software application, or between two software applications, and causing the software application to project a desired perceived emotional expression in an attempt to elicit a desired response from the other participant in the metaphorical call. It should be noted that the emotion recognition/emotion projection functions disclosed herein can be incorporated into the software application, or can be incorporated into a secondary software application that interacts with the primary software application (such secondary software application sometimes referred to herein as an “emotion-wrapper).

By allowing the software application itself to have access to the emotions that the other participant in the metaphorical call perceives the software application to have (and thereby allowing the software application to have, in effect, emotional self-awareness), the software application (or the emotion-wrapper around the software application) can provide the user emotionally expressive feedback, on top of whatever substantive behaviors the software application is designed to perform. There are many systems and methods known in the art to read the projected emotional state of the user, and the presently disclosed embodiments contemplate the use of any such system or method, whether now known or subsequently developed. For example, the user's projected emotional state can be determined from such cues as the user is red in the face, the user's tone of voice, the user's rate of speech, or loudness of speech, to name just a few non-limiting examples. Additionally, an artificial intelligence system can utilize deep learning to recognize emotions, such as by training on conversations where the emotional expressions on both sides are known.

It will be appreciated, as discussed in greater detail hereinbelow, that the software application can use this effective emotional self-awareness in a number of ways beyond actually expressing the emotions that the user perceives the software application to be expressing. In many cases, the developers of the software application might be motivated to have the software application express a desired perceived emotional expression more appropriate for the software application's desired outcome(s). For example, if the software application learns that the user perceives the software application to be expressing (by virtue of its behavior) aggression, the software application can signal a desired perceived emotional expression that is more polite and customer-appropriate than what the software application would have normally provided as output, like a desired perceived emotional expression of conciliation, respect, humility, etc.

In this way, any interactive software application designed without any thought about emotions can be given emotional augmentation such that the software application can project a desired perceived emotional expression. Game bots, chat bots, customer support software, sales bots, virtual assistants (e.g., smart speakers, such as AMAZON ALEXA, APPLE SIRI, GOOGLE ASSISTANT, MICROSOFT CORTANA, etc.), to name just a few non-limiting examples, can all be provided emotional augmentation using the systems and methods described herein by allowing them to perceive the user's emotions and using this information to project a desired emotion back to the user. For example, if the software application's perception of the user's current projected emotion indicates to the software application that the user perceived the software application to be passive aggressive, the software application can alter its projected emotional state by changing the tone of its spoken voice from a baseline, changing the rate at which it is speaking, or changing its facial expression (if there is a simulated face associated with the software application's output), to name just a few non-limiting examples.

To do this, a first observation is that a single user emotional expression does not uniquely determine the ‘most likely’ emotional expression on the other side of the call. That is, there is not a one-to-one mapping from the emotional expression of the user on this side of the metaphorical call to perceived emotional expression on the other side of the metaphorical call.

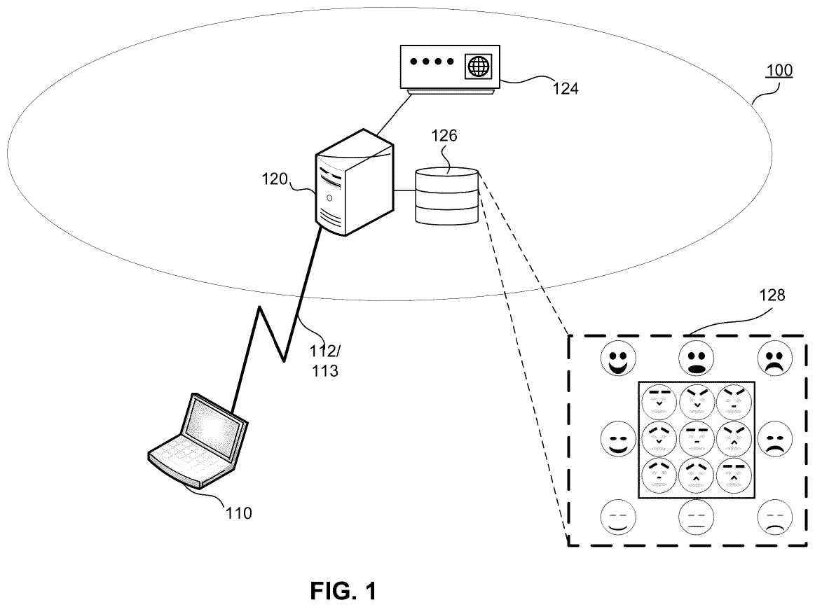

FIG. 1 illustrates a system 100 for emotional augmentation of emotionless software by inference from user emotions, according to some embodiments. As shown, system 100 can include a user device (e.g., a participant) 110 in communication with a computer 120 (also referred to herein as emotional augmentation computer 120). User device 110 and computer 120 can be configured to communicate signals 112 and 113. According to some embodiments, signals 112 and 113 can include one or more emotion attributes that include information about an emotional characteristic expressed by one or more of participant 110 and/or computer 120.

According to some embodiments, computer 120 can be configured to include a communication module 124 and an emotional augmentation module 128, such as an emotional augmentation module 128 stored within memory 126. In some embodiments, upon initiating a call with a participant in communication with communication module 124, emotional augmentation module 128 can be configured to perform communications having an emotion attribute. For example, in some embodiments, computer 120 can be configured to initiate a call (e.g., communicate) with a participant (e.g., participant 110) in communication with a communication module 124 of computer 128.

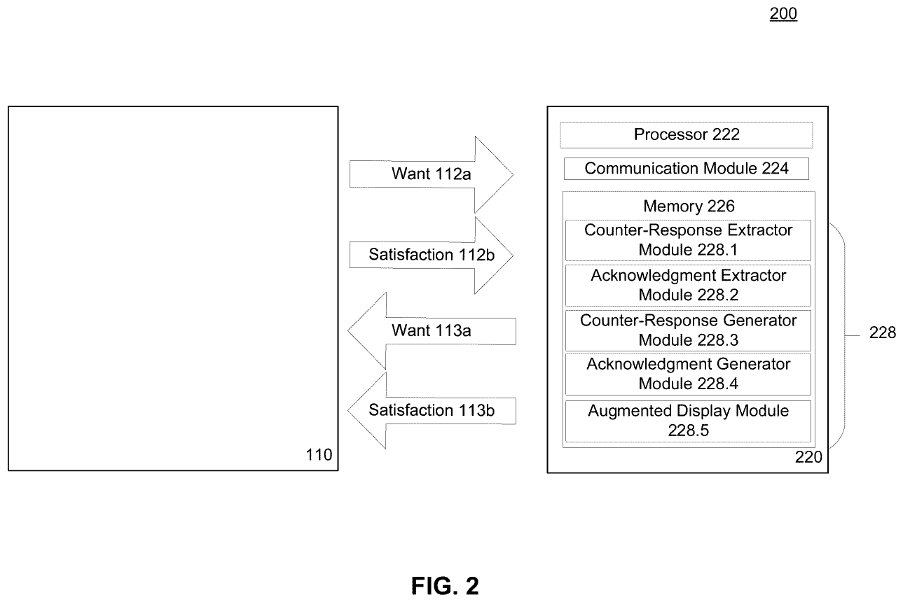

Computer 120 can be configured to receive a first communication 112 from participant. The first communication can include an emotion attribute (e.g., 112a and/or 112b as discussed hereinbelow with respect to FIG. 2) comprising information about an emotional characteristic expressed by the participant. Emotional augmentation module 128 can be configured to evaluate, utilizing one or more processors of the computer 120, the emotion attribute expressed by participant 110 from first communication 112.

Computer 120 can be further configured to generate, utilizing emotional augmentation module 128, an emotion feedback attribute based on the emotion attribute. According to some embodiments, emotion feedback attribute can be intended by computer 120 to elicit a response from participant 110. Computer 120 can be configured to output, utilizing communication module 124, a second communication 113 comprising the emotional feedback attribute.

FIG. 2 illustrates a system 200 for emotional augmentation of emotionless software by inference from user emotions, according to some embodiments. According to some embodiments, system 200 can be an embodiment of system 100. As shown, system 200 can include a user device (e.g., a participant) 110 in communication with a computer 220 (which may be an embodiment of emotional augmentation computer 120). User device 110 and computer 120 can be configured to communicate signals 112a, 112b, 113a, and 113b. According to some embodiments, signals 112a, 112b, 113a, and 113b can include one or more emotion attributes that include information about an emotional characteristic expressed by one or more of participant 110 and/or computer 220.

Computer 220 can include one or more processors 222, one or more communication modules 224, and at least one memory 226. According to some embodiments, memory 226 can include one or more modules 228 (e.g., software modules, applications, or the like). For example, memory 226 can include module 228 that includes the modules (e.g., sub-modules) counter-response extractor module 228.1, acknowledgement extractor module 228.2, counter-response generator module 228.3, acknowledgment generator module 228.4, and augmented display module 228.5.

By way of theoretical example, supposing, ad absurdum, that there was a one-to-one mapping between emotional expressions on either side of the metaphorical call. Let this side of the metaphorical call be participant 110, and the other side of the metaphorical call be emotional augmentation computer 120. If emotional expressions are presumed as a turn-taking “conversation” back and forth, then, by assumption, participant 110's expression now uniquely determines emotional augmentation computer 120's previous expression. If there were a one-to-one mapping, then emotional augmentation computer 120's expression also uniquely determines participant 110's immediately-previous expression. And, from that emotional augmentation computer 120 can determine the immediately-previous expression before that, and so on. For example, by determining a single expression from participant 110, emotional augmentation computer 120 is configured to uniquely infer an entire history of emotions expressed in an arbitrarily long history of expressive back-and-forths. However, a turn-taking conversation generally does not follow this idyllic, one-dimensional, history.

For any emotional expression participant 110 might currently have, there are multiple expressions on the other side of the metaphorical call that may have occurred to elicit participant 110's current emotional expression. Learning the emotional expression on the other side of the metaphorical call is therefore more complex than simply recognizing a current emotional expression on this side of the metaphorical call.

Although there may be no one-to-one mapping from participant 110's current emotional expression to emotional augmentation computer 120's previous emotional expression, determining the sequence of emotional expressions on this side of the metaphorical call can permit emotional augmentation computer 120 to infer the emotional expressions on the other side of the metaphorical call.

Emotional expressions are multi-faceted (multi-dimensional), and any user's emotional expression (including that of a software application projecting a desired perceived emotional expression) possesses information about: (a) participant 110's satisfaction signal 112b concerning what the other agent said he wants (two exemplary emotion dimensions related to “satisfaction” are happy-unhappy and surprised-relaxed); and (b) participant 110's want signal 112a (two exemplary emotion dimensions related to “want” are aggressive-conciliatory and serious-casual). Machine 120 can be configured to separate a full emotional expression into these two facets. According to some embodiments, frameworks are provided to explain how this occurs. In additional embodiments, machine learning processes can be performed by emotional augmentation computer 120 to provide this capability to a software application.

According to some embodiments, counter-response extractor module 228.1 is configured to assess want signal 112a corresponding to an acknowledgement emotion space, described in detail below. According to some embodiments, acknowledgement extractor module 228.2 is configured to assess satisfaction signal 112b corresponding an acknowledgement emotion space, described in detail below.

According to some embodiments, where determining emotional augmentation computer 120's emotional expression cannot be performed based on a current emotional expression of the other participant on the metaphorical call, emotional augmentation computer 120 can nonetheless be configured to map from one of the facets of other participant 110's emotional expression to one of the facets of emotional augmentation computer 120's emotional expression. According to some embodiments, based on an emotional expression by the other participant of the other participant 110's want signal 112a, emotional augmentation computer 120 can generate a satisfaction signal 113b. According to some embodiments, counter-response generator module 228.3 is configured to generate want signal 113a corresponding an acknowledgement emotion space, described in detail below. According to some embodiments, acknowledgement generator module 228.4 is configured to generate satisfaction signals 113b corresponding an acknowledgement emotion space, described in detail below. In some embodiments, an augmentation display module 228.5 may render a communication (symbol, avatar, text, voice, etc.) that is intended to communicate want signal 113a and satisfaction signal 113b to a user device (e.g., participant 110) for display, for example, in a user interface of the user device.

For example, based on a determination (i) where the other participant 110 was more aggressive, emotional augmentation computer 120 may enter a state of being less happy, or (ii) where the other participant 110 was more serious, emotional augmentation computer 120 may enter a state of being more surprised. Machine 120's satisfaction signal 113b can be generated and communicated based on this determination.

From other participant 110's satisfaction signal 112b (based on what emotional augmentation computer 120 wants or did), it is possible to infer the machine's want signal 113a. In particular, based on a determination that the other participant 110 is happier, there may be an inference that the software application was less aggressive. Based on a determination that the other participant 110 is more surprised, an inference may be computed that the software application was more serious.

A machine can therefore be configured to calculate (a) the software application's satisfaction signal (happy, surprise) from other participant 110's previous want signal (aggressiveness, seriousness); and/or the software application's want signal (aggressiveness, seriousness) from other participant 110's subsequent satisfaction signal (e.g., happy, surprise, etc.).

Such determinations can have temporal consequences. For example, a machine (e.g., module 128 such as a software application) can generate a satisfaction signal (e.g., happy, surprise, etc.) after other participant 110's emotional expression is read, potentially even before the module 128 has actually displayed a behavior.

According to some embodiments, module 128 can be further configured to determine a first score associated with a predictive level of certainty associated with the emotion attribute and a second score associated with a price of disengagement, wherein the second score represents a metric of social capital associated with the emotional attribute. In some embodiments, module 128 can be configured to generate emotion feedback based on one or more of the first score and the second score. In some embodiments, module 128 can be configured to generate the emotion feedback attribute based on one or more intended personality traits (e.g., one or more active or passive personality traits, as described in detail below).

According to some embodiments, a want signal (aggressiveness, seriousness), however, may not be computed directly by the module 128 after having displayed its behavior, because it must be inferred from other participant 110's subsequent satisfaction signal. Once the other participant 110 expresses his/her subsequent full emotion, the satisfaction signal can be isolated by module 128 to be used to infer the previous want signal transmitted by module 128. The want signal may therefore be delayed to perform this process.

However, the other participant 110 may, instinctively and emotionally, react quickly. If participant 110's satisfaction signal 112b is quickly determined, then module 128 can express a corresponding want signal 113a in real time with the participant 110's subsequent emotional expression 112.

Machine 120's full emotional expression can then be augmented (i.e., morphed) from the current full emotional expression (its earlier satisfaction signal 113b combined with its currently calculated want signal 113a) to communicate a new partial emotional expression, where the new partial emotional expression is based on the new satisfaction signal 113b calculated from other participant 110's new want signal 112a.

And this cycle can continue. One path to emotional self-awareness for the emotional augmentation computer 120 is to recognize the mappings discussed herein. Namely:
(a) previous wants of the other participant can be associated with current satisfaction attribute of emotional augmentation computer 120 (desired perceived emotional expression);
(i) previous aggressiveness of the other participant 110 can be associated with current emotional augmentation computer 120 unhappiness (desired perceived emotional expression);
(ii) previous seriousness of the other participant 110 can be associated with current emotional augmentation computer 120 surprise (desired perceived emotional expression);
(b) current satisfaction of the other participant 110 can be associated with current emotional augmentation computer 120 wants (desired perceived emotional expression);
(i) current unhappiness of the other participant 110 can be associated with current emotional augmentation computer 120 aggressiveness (desired perceived emotional expression);
(ii) current surprise of the other participant 110 can be associated with current emotional augmentation computer 120 seriousness (desired perceived emotional expression).

According to some embodiments, different software applications can scale the above mappings in ways appropriate for their needs. That is, if the other participant 110 becomes more aggressive, the software application can become more unhappy (by virtue of the mapping), but the software application can instead, for example, still express happiness, albeit just a little less happiness than was signaled earlier. The software application can keep true to the isomorphisms but compress or extend them as needed to achieve the personality characteristics suiting its needs.

For example, for a typical customer-centric scenario,
(a) for the software application's satisfaction signal 113b, the software application wishes to appear satisfied (both happy and unsurprised) with what the other participant 110 wants.
(b) for software application's want signal 113a, the software application wishes to appear reasonable (not aggressive, and at some comfortable level of seriousness) in the software application's request.

The combination of these two facets should lead to whole desired perceived emotional expressions like appreciative, modest, hospitable, and so on, rather than, say, expressions like disgusted, appalled, insulted, sneering or proud.

But, in contrast, a poker bot software application may prefer to express the emotion actually perceived by the other participant—or perhaps even exaggerate the software application's hostility level—to make for a more interesting game experience.

In another embodiment, systems and methods are provided, (for example, in a customer service setting) to enable emotional augmentation computer 120 to collect data and provide insight regarding customer (e.g., participant 110) satisfaction, a customer's level of seriousness, the customer's wants, the customer's opinion of the other party, the customer's confidence, the customer's disagreeableness, the social capital risked by the human or the software application, the extent to which the interaction has gotten “out of hand” with a danger of embarrassment, and a lost customer, etc.

The methods and processes described above can be further understood in connection with the following Examples. In addition, the following non-limiting examples are provided to illustrate the invention. The illustrated exemplary methods and processes are applicable to other embodiments of the present invention. The processes, described as general methods, describe what is believed will be typically effective to perform the method indicated. However, the person skilled in the art will appreciate that it may be necessary to vary the procedures for any given embodiment of the invention, e.g., vary the order or steps and/or the software application used.

### Application of Emotional Augmentation of Emotionless Software

A user experience (UX) machine can generally be defined as a machine (e.g., emotional augmentation computer 120) having an objective to modify the user's emotions or actions to enhance the user experience. Example 1, as described below, may be characterized as an example of a broad class UX machine. The example concerns a machine configured to measure the user's emotional expression, thereby inferring its own emotion it was perceived to have expressed and using the inference to determine how to proceed.

A devising machine, as referred to herein, can be configured having an objective to steer or guide the user toward some range of emotions or actions. Example 2 described below is an example of a devising machine and would fall under this broad category. Example emotion states a machine (e.g., emotional augmentation computer 120) may try to devise can include: maintaining a relaxed interaction, maintaining a positive (happy) state of the user, convincing the user that the machine (e.g., emotional augmentation computer 120) is in a positive (happy) state, keeping the perceived social capital at stake by the user low, such that there may be low or no risk of humiliation, etc. User actions that the machine may attempt to achieve can include, for example, to fully agree to a refund, to listen to more of an ad, to buy a subscription, etc.

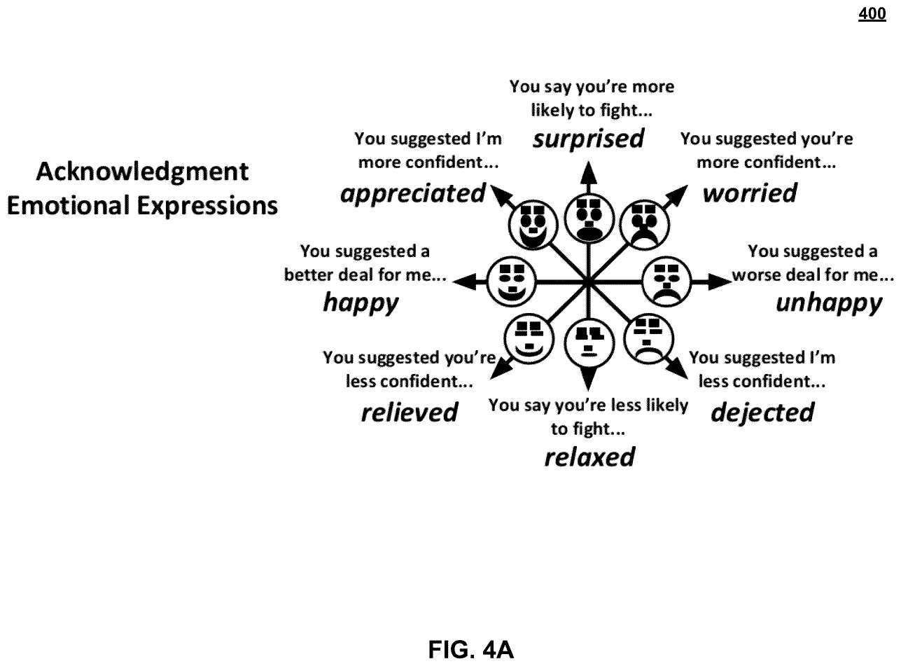

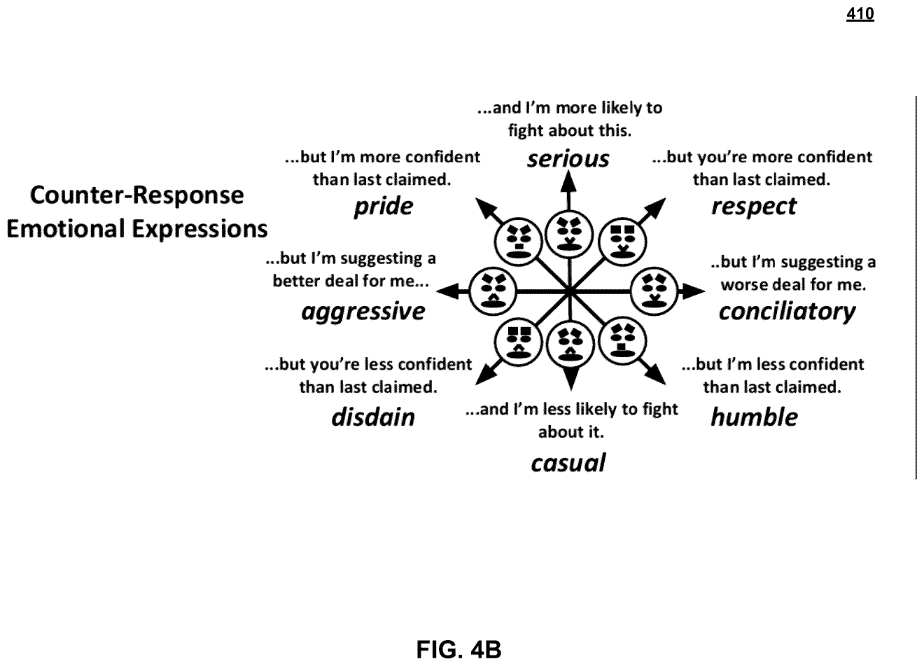

Counter-responses are emotional expressions that convey what the bearer wants, and how serious he is about it. These include emotions such as respect, disdain, humility, seriousness, and aggression. As described below, FIGS. 4A and 4B illustrates all the qualitatively distinct emotional expressions in this two-dimensional space, and how each emotional expression relates to what the user (e.g., participant 110) wants and his level of seriousness. Asking for more or less is the meaning of the pair of expressions aggression and conciliatory. Seriousness concerns the pair of emotional expressions serious and relaxed. The more seriousness a party expresses, the more that party is expressing (1) that he's likely to end the discussion, and (2) that anything another participant subsequently says will be taken more seriously (and amount to larger bets of reputation, so to speak, in that if another participant is later found out to be wrong or have to back down, it's more humiliating).

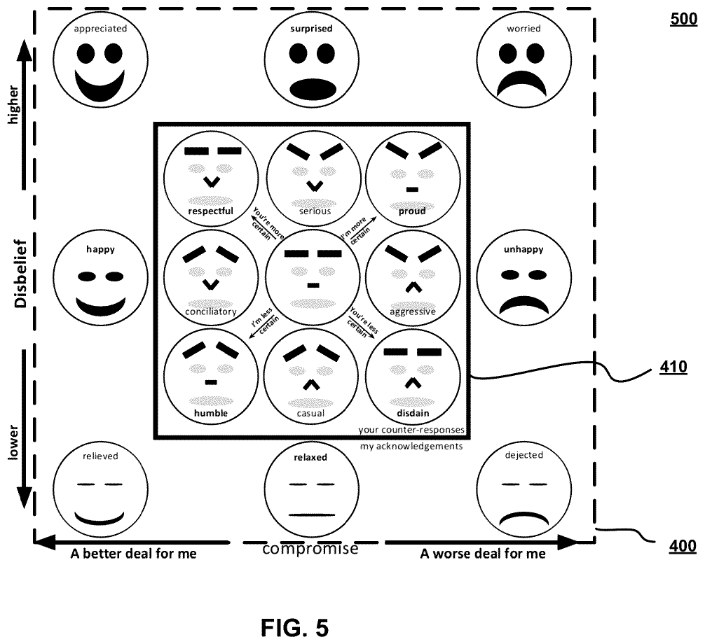

Acknowledgments are a distinct class of emotional expressions that convey receipt of the other party's counter-response. They also convey the bearer's reaction to the other party's want and seriousness. Or, intuitively, they express how the bearer feels about what the other party just expressed with his counter-response. These include emotions such as happy, surprised, relaxed and appreciated. FIG. 4B shows all the qualitatively distinct emotional expressions in this two-dimensional acknowledgment space. FIG. 5 shows which counter-response (inner square) each acknowledgment expression serves to acknowledge. For example, if participant 110 expresses aggression (participant 110 wants more), acknowledgment by emotional augmentation computer 120 may be unhappy (at a magnitude consistent with the size of participant 110 request, and meaning “participant 110 just said participant 110 wants this much more”). If instead participant 110 express seriousness, acknowledgment by emotional augmentation computer 120 may be generated as surprise (providing receipt that participant 110 just raised the level of seriousness).

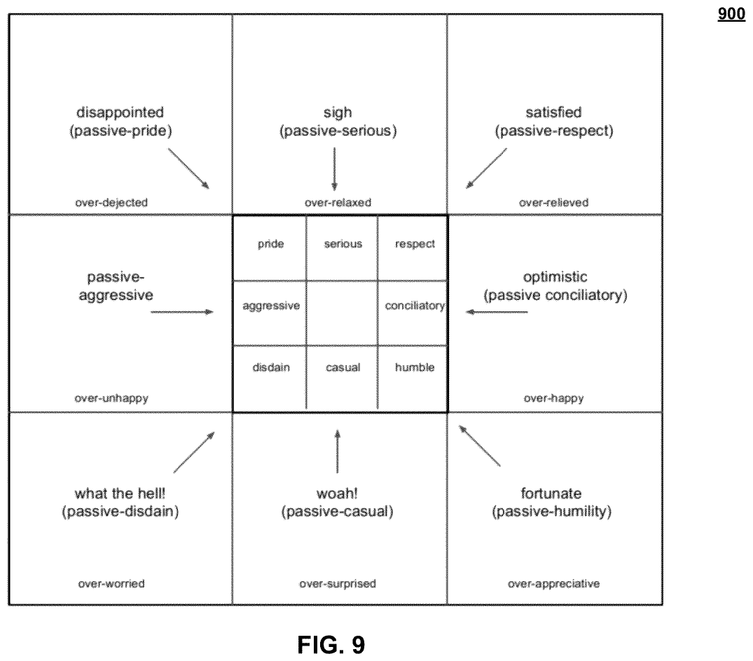

Full emotional expressions are combinations of acknowledgments and counter-responses. For example, perhaps emotional augmentation computer 120 expressed the acknowledgment unhappy (because participant 110 was just aggressive), and now emotional augmentation computer 120 expresses pride (signaling emotional augmentation computer 120 wants more and is serious about it). The combination of unhappy and pride is something close to angry. FIG. 9 shows the full space of all combinations of the acknowledgments with counter-responses.

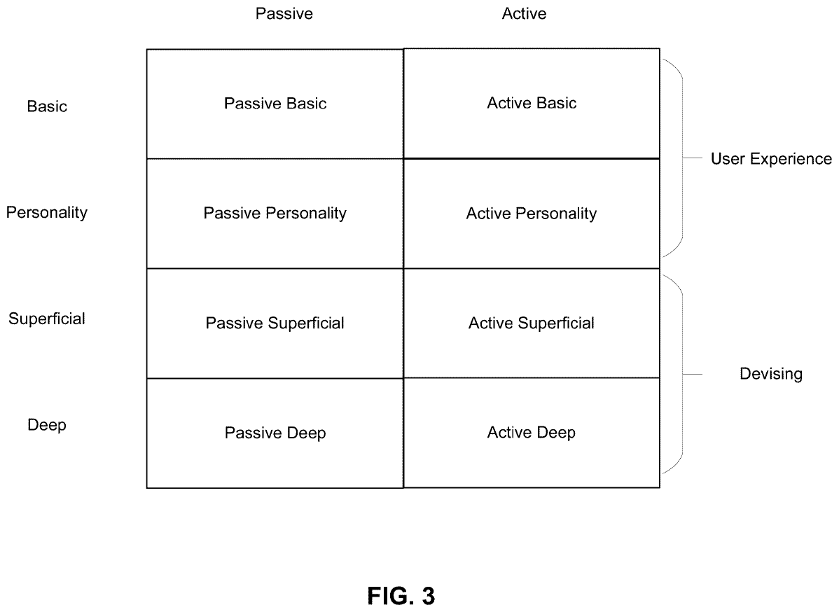

As depicted in FIG. 3, two additional characteristics that can be provided by a machine configured for emotional augmentation by emotionless software are disclosed. Specifically, a machine can be configured as a passive machine and/or as an active machine.

Passive machines are defined as machines configured to measure the user's counter-response expression (via either measured expressions from text/voice/face/etc. or user behavior itself) and compute the appropriate acknowledgement to express. Acknowledgments, being reactions to the other party's demands rather than demands of their own, are accordingly more passive, and thus the name.

Active machines, on the other hand, are defined as machines configured to measure the user's most recent acknowledgement and infer the counter-response the user perceived the machine to have expressed. The machine can use that information to either quickly express (after-the-fact) the emotion the user perceives the machine to have implicitly expressed (as in an active-basic, e.g., UX-veridical case as depicted in the top right portion of FIG. 3), or use that self-knowledge of what it had implicitly expressed to guide its next counter-response expression.

Passive and Active machines are not mutually exclusive. A machine can have both features, although it will be helpful to keep the distinction for separating distinct sorts of example categories.

FIG. 3 additionally depicts four rows: Basic, Personality, Superficial, and Deep. For example, machines having a “basic” characteristic can be defined as meaning that the machine uses emotional expression information from the user to infer its own emotion to express (by emotional augmentation), and does so in the most “basic” fashion.

For passive machines, a “passive-basic” characteristic can be defined as meaning the machine measures the user's counter-response, and expresses the appropriate (i.e., genuine or veridical) expression acknowledging that. In some embodiments, a passive-basic machine may be considered the simplest sort of emotional augmentation machine, one that passively gives the appropriate response to the user's expressions of his demands.

For active machines, an “active-basic” characteristic can be defined as meaning that the machine measures the user's acknowledgment, and expresses the counter-response that that acknowledgment expression acknowledges, thereby explicitly expressing what the user perceived the machine to implicitly be expressing by virtue of its actions. Expressing this veridical counter-response is after the fact but might nevertheless enhance the user experience.

In one non-limiting example, a virtual assistant can be configured to convey that the (passive-basic) machine is in response to a determination that the user is conciliatory. For example, user agreed to listen to more of an ad and the passive-basic machine expresses a happy trait. Or the passive-basic machine expresses that it is relaxed in response to a determination that the user expresses that he's casual (and, e.g., is therefore open to continued negotiation and discussion.) In another example, an active-basic machine may be configured such that, when a

user expresses a happy emotion, a determination can be inferred that the machine previously implicitly expressed a conciliatory emotion. The active-basic machine (virtual assistant) may then express a conciliatory emotion, an after-the-fact display so as to fit the user's perception.

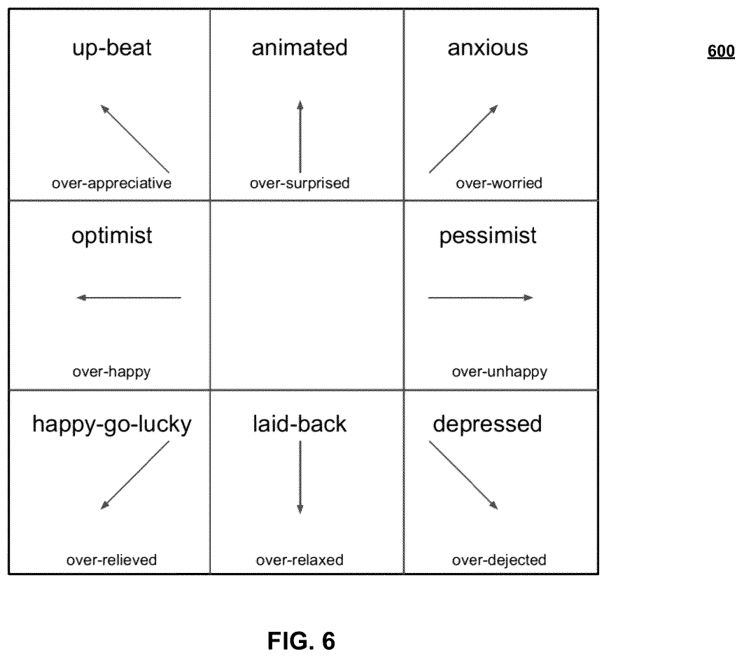

Machines having a “personality” characteristic can be defined as meaning that, rather than expressing “veridically” as it does in the basic case, a machine can have a systematic tendency to express an emotion that deviates from the veridical one. By doing so, the machine thereby not only manages to provide basic emotional expressions as in the basic case but manages to convey a personality. Three varieties of personality are depicted in FIGS. 5 and 6, as described in detail below. These varieties can include, in a non-limiting example, two varieties of passive personality spaces (dispositions and temperaments) and one active personality space (natures).

For example, virtual assistant device may be configured as a passive-personality machine, that is, having a personality trait such as happy-go-lucky, anxious, etc. Or, in a gaming application, a developer may configure a machine such that an interactive character has a particular personality type, such as manic, professional, etc. In another example, a virtual assistant device can be configured as an active-personality machine, i.e., determining a counter-response to convey a personality trait, such as humble, or the like. Or, in a gaming application, a designer may provide an active-personality orientation to give a character a “disdainful” personality type.

These two rows described above, basic and personality, are associated as UX rows in the table. Each row is oriented toward the user experience, not concerned with affecting the user into certain emotions or actions. The following two rows, however, concern devising machines having an objective to manipulate or coax a user into certain ranges of emotions or actions.

Machines having a “superficial” characteristic can be defined as meaning that the machine can be configured to possess UX features, but, in addition, can modulate its emotional expressions with the aim to goad the user into having certain emotions or taking certain actions. These are “superficial” because the underlying machine behavior is unchanged; these emotional expressions “float atop” that machinery.

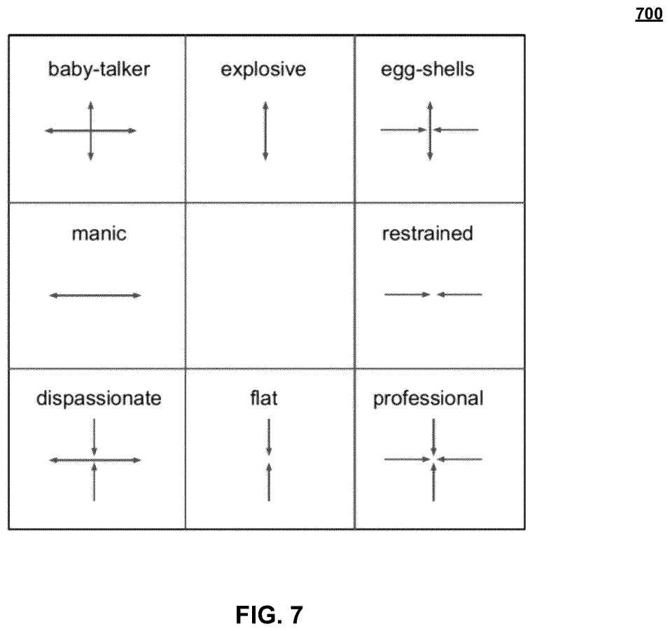

For passive-superficial machines, according to some embodiments, a machine is configured to express counter-responses passively, only using acknowledgments, as described below with reference to FIG. 7. Passive-Aggression is the most familiar such emotional expression, which one might express not by being aggressive (which is an active counter-response) but by being less happy than one would expect given the other's expression. In many circumstances it may be more appropriate to convey what the machine wants passively, rather than actively. The machine can employ non-systematic deviations from the veridical acknowledgement to express passive counter-responses (including, e.g., passive-aggressive) aimed at passively guiding the user toward certain emotional states or actions.

In one non-limiting example, a passive-superficial machine can be configured to implicitly steer the user toward a customer support compromise without ever explicitly expressing this objective (want). Instead, the machine passively expresses acknowledgment reactions in ways that suggest what it really wants. For example, in the field of customer service industries, expression of an explicit objective can be considered rude by a user. Therefore, a passive-superficial machine can be configured more appropriately to passively express an objective.

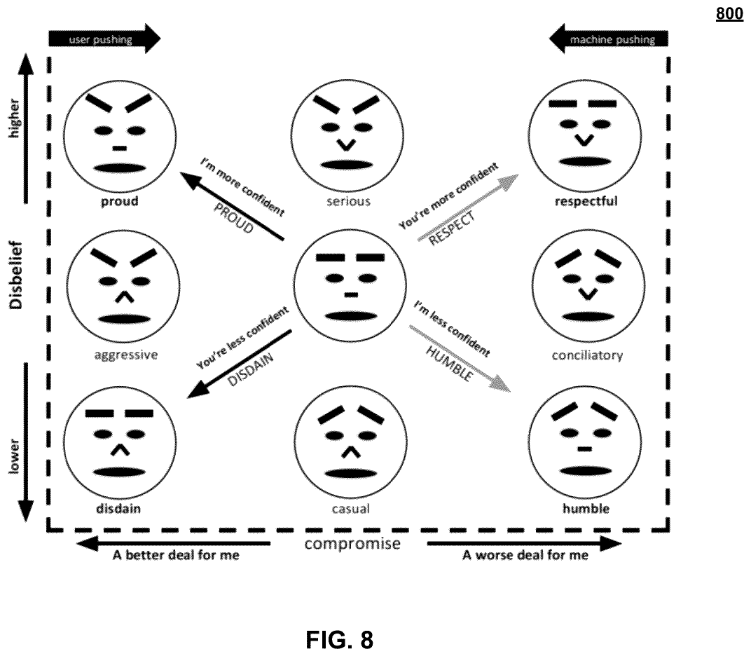

For active-superficial machines, using self-knowledge of the perceived counter-response it previously made (by virtue of measuring the user's acknowledgment) the machine can choose a next counter-response configured to coax the user toward an intended objective, as further described below with reference to FIG. 8. In one non-limiting example, an active-superficial machine may determine based on a user response that the machine has been perceived as overly aggressive. The machine can modify its previous (after-the-fact) and upcoming counter-response to help correct that, and convey something more conciliatory, with an objective to orient the user toward agreement to play again. In another example, a game may be designed to include an “evil” character whose aim is to enrage the player, even though the character's underlying actions are not modified.

Machines having a “deep” characteristic are further defined and configured to enable the machine's actual underlying behavior to be modified as a function of the emotional expressions it measures from the user. Example 2 as described below, may be an example of a deep machine, for example, an active-deep machine.

For example, a “passive-deep” machine can be configured as having an objective of orienting a user toward certain emotional states or actions, as described further with reference to FIG. 7 below. For example, a passive-deep machine may attempt to dismiss an unwanted participant, such as a salesman, purely by acknowledgments to the salesman.

Like a “passive-deep” machine, an “active-deep” machine can also be configured as having an objective of coaxing the user toward certain emotional states or actions, as described further with reference to FIG. 8 below. For example, a machine may determine what to express as a counter-response to coax the salesman to leave.

Accordingly, an emotional augmentation computer 120 having an emotional augmentation function can be configured to broadly encompass augmentation characteristics selected from at least one of eight categories depicted in FIG. 3.

FIGS. 4A and 4B illustrate two 2-dimensional spaces 400 and 410 of emotional expressions that participant 110 and computer 120 can use to carry out communications and negotiations. A total emotional expression would consist of an acknowledgment and a counter-response.

More specifically, FIG. 4A illustrates an acknowledgment expression 400, which can be defined as an emotional expression of the bearer's passive reaction to, or confirmation of receipt of, what the other party expressed it wants (via a counter-response). It can be measured from the user's emotional expression (from face, voice, text, etc.). It is veridical if it accurately confirms receipt of the other party's counter-response.

FIG. 4B illustrates a counter-response expression 410, which can be defined as an emotional expression of what (and how much) the bearer wants, and his level of seriousness (greater levels of which suggest the bearer is more likely to abandon “talking” about it, and going to the “next level”). It can be measured from the user either via the user's emotional expression itself (from face, voice, text, etc.) or inferred/computed from the user's action.

FIG. 5 depicts the relationship of emotion spaces of at least two participants in a communication (e.g., a negotiation or the like). For example, an outer emotion space can correspond to an acknowledgement expression 400 of a participant, such as participant 110. An inner emotion space can correspond to a counter-response expression 410 of another participant, such as computer 120.

That is, the two-dimensional space of acknowledgement emotional expressions are on the outside, each next to the counter-response emotional expression it acknowledges in the inner square. So, for example, a participant's unhappy expression acknowledges the other participant's aggressive expression, and a participant's surprised expression acknowledges the other participant's serious expression.

For passive-basic cases (e.g., top left portion of FIG. 3), the machine infers the user's counter-response emotional expression from among the two-dimensional space shown in the center here. The machine then expresses the acknowledgment emotional expression from among the states outside of the counter-response space, veridically providing receipt of the user's counter-response. Machine inference is “in to out.” For example, perhaps the user expresses he's serious, wanting an urgent resolution to the matter, in which case the machine responds with surprise, expressing that the machine got the message. Or perhaps the user expresses aggression, and the machine expresses unhappy, the veridical receipt to an expression of aggression. For Active Basic cases (top right in FIG. 3), the machine inference is the opposite, “out to in.” For example, perhaps the user expresses happiness, which means that the user interpreted the machine to have been conciliatory (and the machine might not have even tried to be conciliatory, nor to have expressed any emotion at all per se). To help with user experience, the machine now expresses the counter-response emotion of conciliatory, thereby (after-the-fact) having the explicit emotional expression the user perceives it to have already implicitly expressed.

According to some embodiments, an inner square's emotional expressions are horizontally flipped compared to the emotional expressions of FIGS. 4A and/or 4B to properly associate the emotional expression a participant just signaled, and that another participant acknowledges. Although certain emotional expression terms are provided for the acknowledgments of the four corner cases, (e.g., appreciated acknowledges respectful, worried acknowledges pride, etc.), one of ordinary skill in the art would understand that additional terms and relationships may be suitable in addition to those depicted.

FIG. 6 illustrates passive personalities and dispositions for identification and emulation, according to some embodiments. According to some embodiments, machine 120 can be configured to embody an emotion-related personality type by configuring machine 120 to express an acknowledgment that systematically deviates from the veridical one given the counter-response the user just expressed. As shown in FIGS. 6 (dispositions) and 7 (temperaments), two distinct 2D spaces of personalities can be achieved in this way, and discussed for a passive-personality attribute. As shown in FIG. 6, dispositions are a systematic (although possibly random) tendency to have an associated acknowledgment attribute shifted in some direction. For example, a personality that is happier than what is customarily expected in view of what the other party just did. The participant is happier than expected when happy, and less unhappy than he should be when unhappy. This “optimist.” (i.e., “over-happy”) personality attribute may be depicted by a leftward shift in the space 600 of FIG. 6, corresponding to the leftward orientation of “happy” in the acknowledgment space illustrated in FIG. 4A. This leads to this two-dimensional space of disposition personality types.

As shown in FIG. 7, in some embodiments, a machine can be configured to express an acknowledgment that systematically deviates from the veridical one given the counter-response the user just expressed, as another way to render an emotion-related personality type in the context of dispositions. But whereas dispositions always shifted in the same direction (an additive shift), a shift that occurs with respect to the temperament concerns whether it is larger or smaller (a multiplicative shift). For example, a personality can be rendered happier than it should be when happy, and unhappier than it should be when unhappy. This personality may be said to have a manic personality. To portray this personality trait, the left side (middle) square here is shifted as shown by two outward-pointing horizontal arrows. An opposite case can involve a more restrained personality trait, showing less happiness and less unhappiness than is veridical (right side, middle). To portray a personality that isn't happier or unhappier than he should be, but can be easily aroused, and can, on the other hand, suddenly become casual at a hair trigger, the temperament traits can be shifted, i.e., to the top-middle (“explosive”). The opposite (bottom-middle) would be portrayed as the personality type that is ever “flat.”

As shown in FIG. 8, for active personalities another way to give a machine an emotion-related personality type is to, rather than modifying its acknowledgment expressions, modify its counter-responses, based on the active-personalities portion of FIG. 3. One simple way within this class is to configure a machine to portray a tendency to express counter-responses shifted in one direction within counter-response space. This may be considered as the entity's “nature.” That is, the counter-response traits can be interpret as personalities (“natures”) rather than individual expressions. For example, an entity is aggressive if he has a greater than usual tendency to be aggressive. It can still be configured to express the full range of counter-response emotions, but overall the average across his expressions are shifted more than average in an “aggressive” direction.

As shown in FIG. 9, for passive personalities, it is possible to have a machine express counter-responses passively through acute deviations of its acknowledgments, rather than explicit counter-response expressions, which amounts to a less assertive way of saying what it wants and its seriousness level. For example, if participant 110 was conciliatory, the machine would usually express happy to acknowledge that. However, for a machine 120 that only expresses half the level of happiness expected for a veridical acknowledgment, machine 120 is thereby implicitly expressing an emotion attribute that conveys, “that's not nearly as good an offer as you think it is” and that the machine wants a better offer. This is shown at the left side, middle row. In other words, the machine's acknowledgment can be shifted by algorithm in the unhappy direction amounting to a passive expression of aggression, i.e., passive-aggressive. If the user instead expresses serious, and supposing the machine by algorithm expresses twice as much surprise as is veridical, machine 120 intuitively expresses an emotion attribute that conveys “Woah, calm down!”, exaggerating its level of surprise. So, machine 120 conveys an exaggerated surprise acknowledgement to the user's counter-response of serious amounts to the machine's passive expression of casual (i.e., “woah!”). As shown in FIG. 9, this trait is depicted in the bottom, central square, and the upward arrow indicates that the acknowledgment is more surprised than it should be. A machine configured to portray personality traits based on FIG. 9, may be considered a devising machine, as shown in FIG. 3 (e.g., Superficial and/or Deep). As described above, these categories can correspond to a machine 120 objective to coax the user toward some range of emotions or actions. In the Superficial category, the emotional expressions of counter-responses float atop the unchanged machine actions, whereas in the Deep category the machine may be modifying its underlying behavior. In the Passive column, all emotional signals are done only via acknowledgments, including employing the deviations-from-veridical discussed in this figure which allow acknowledgments to also serve as passive counter-responses.

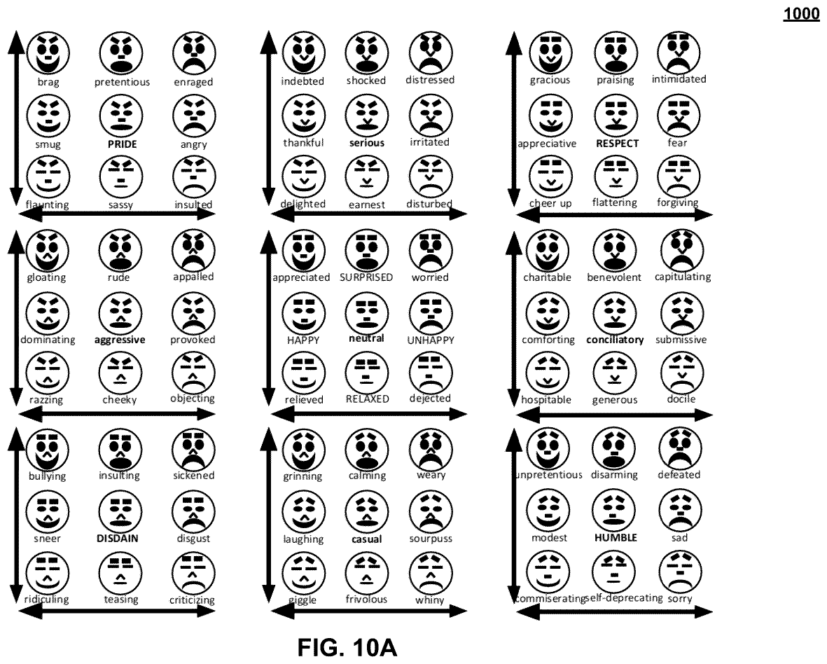

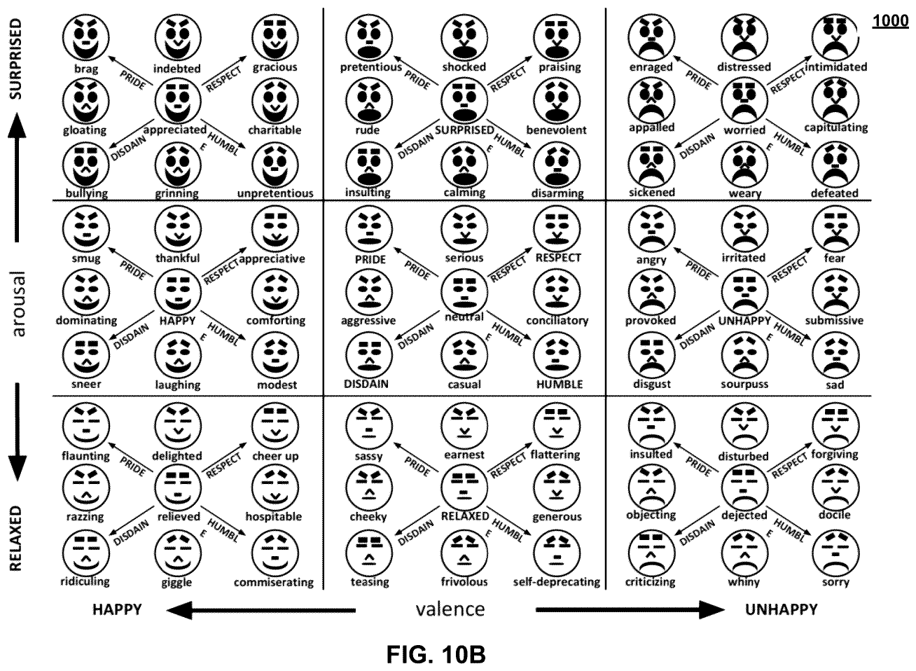

FIGS. 10A and 10B illustrate a 2D space exhibiting a more complete array of emotions than the 2D space of acknowledgments, and 2D space of counter-responses, from FIG. 4A and FIG. 4B. As shown, the array can include 81 qualitatively distinct emotional expressions. In FIG. 10A, these expressions have been grouped by counter-response. Each counter-response is at the center of its group, surrounded by the emotional expression resulting from combining it with each of the qualitatively distinct acknowledgment expressions. FIG. 10B is the same as FIG. 10A, but now grouped by acknowledgment instead.

### Example 1

In an exemplary embodiment, a method according to the present disclosure can include the process whereby a participant A (which may be an embodiment of participant 110 or emotional augmentation computer 120 of FIGS. 1 and 2) acquires input data regarding a current emotional state of a participant B (which may be an embodiment of participant 110 or emotional augmentation computer 120 of FIGS. 1 and 2) during a metaphorical call.

In accordance with such an exemplary embodiment, participant A can be an emotionless software application or similar algorithm that has been engineered to interact with participant B to acquire input data from participant B and provide responses to participant B through a natural text, interactive voice recognition or facial recognition interface, or the like. In some examples of an exemplary embodiment, participant B can be a human individual who expresses input data, constituting a signal of a current emotional state of participant B, to participant A through conscious, subconscious, and/or unconscious vocal and/or facial cues.

### 1. A. Participant B's Initial Expression of Input Data to Participant A

When participant A initially acquires input data from participant B constituting a signal of an initial current emotional state of participant B, participant A will interpret the input data to provide an initial measurement regarding the initial current emotional state of participant B. It will be understood that participant A may or may not have previously measured any emotional state of participant B at any specific point in time. Accordingly, participant A's initial measurement of the observable initial current emotional state of participant B may or may not be an accurate measurement of the actual initial current emotional state of participant B, and participant A's initial measurement of the observable initial current emotional state of participant B can optionally include some estimated amount of uncertainty in such measurement.

Further, when participant A initially acquires input data from participant B constituting a signal of the observable initial current emotional state of participant B, participant A may only interpret the input data transmitted to participant A by participant B to provide an initial measurement regarding the initial current emotional state of participant B. It will be understood that participant A may be cognizant that participant B may be expressing input data, constituting a signal of an observable initial current emotional state of participant B, to participant A, which may intentionally or unintentionally, and consciously or subconsciously, vary from an actual initial current emotional state of participant B. Accordingly, participant A's initial measurement of the observable initial current emotional state of participant B can optionally include some estimated amount of uncertainty in participant B's accurate expression of input data regarding participant B's actual initial current emotional state compared to participant B's observable initial current emotional state.

Further, when participant B initially expresses input data to participant A, it will be understood that participant B may be cognizant that participant A may inaccurately interpret the input data initially expressed by participant B to participant A. Accordingly, participant B's initial expression of input data to participant A may or may not, intentionally or unintentionally, and consciously or subconsciously, reflect the actual initial current emotional state of participant B insofar as participant B may be motivated for participant A to achieve a specific interpretation and measurement of the observable initial current emotional state of participant B. Consequently, participant B's initial expression of input data to participant A can optionally include some amount of uncertainty in participant B's actual initial current emotional state compared to participant B's observable initial current emotional state.

Further, when participant B initially expresses input data to participant A, it will be understood that participant B may or may not be cognizant that participant B is expressing input data to participant A, which may unintentionally, and subconsciously or unconsciously, vary from an actual initial current emotional state of participant B. Accordingly, even where participant B may not be motivated for participant A to achieve a specific interpretation and measurement of the observable initial current emotional state of participant B, participant B's initial expression of input data to participant A can optionally include some amount of uncertainty in participant B's actual initial current emotional state compared to participant B's observable initial current emotional state by virtue of the discrepancy between participant B's conscious expression and subconscious or unconscious expression.

### 1. B. Participant A's Initial Expression of Output Data to Participant B

In an exemplary embodiment, a method according to the present disclosure can further include the process whereby participant A provides output data to participant B in response to the input data regarding the initial current emotional state of participant B.

Following participant A's interpretation of the input data transmitted to participant A by participant B, and participant A performing an initial measurement regarding the observable initial current emotional state of participant B, participant A can provide output data to participant B constituting a signal expressed by participant A to participant B. The signal provided by participant A to participant B can include an acknowledgement and a counter-response in some embodiments.

In accordance with an exemplary embodiment, an acknowledgement by participant A can include recognition by participant A of what participant B expects will be the first participant's interpretation and measurement of the observable initial current emotional state of participant B as well as what participant B expects will be the amount of uncertainty in participant A's interpretation and measurement of the observable initial current emotional state of participant B. Further, an acknowledgement by participant A can include recognition by participant A of participant B's observable initial current emotional state as well as the amount of uncertainty that participant A has ascertained is possessed by participant B in participant B's understanding of participant B's observable initial current emotional state as compared to participant B's actual initial current emotional state.

In accordance with an exemplary embodiment, a counter-response by participant A can include expression by participant A to participant B of participant A's actual interpretation and measurement of the observable initial current emotional state of participant B as well as the actual amount of uncertainty in participant A's interpretation and measurement of the observable initial current emotional state of participant B. Further, a counter-response by participant A can include expression by participant A to participant B of participant A's interpretation and measurement of the observable initial current emotional state of participant B as well as participant A's interpretation and measurement of the amount of uncertainty that is possessed by participant B in participant B's understanding of participant B's observable initial current emotional state as compared to participant B's actual initial current emotional state.

### 1. C. Participant B's Second Expression of Input Data to Participant A

In an exemplary embodiment, a method according to the present disclosure can further include the process whereby participant B provides further input data to participant A in response to the output data regarding the interpretation and measurement of the observable initial current emotional state of participant B received from participant A.

Following participant A providing output data to participant B constituting a signal expressed by participant A to participant B, the signal including, in an exemplary embodiment, an acknowledgement and a counter-response, participant B subsequently can express input data to participant A constituting a signal of a second current emotional state of participant B. The second current emotional state of participant B may be a different current emotional state than the initial current emotional state expressed by participant B to participant A, or the second current emotional state of participant B may be the same current emotional state as the initial current emotional state expressed by participant B to participant A. If the second current emotional state of participant B is a different current emotional state than the initial current emotional state expressed by participant B to participant A, the differences between the initial current emotional state of participant B and the second current emotional state of participant B may be conscious, subconscious, or unconscious. Further, if the second current emotional state of participant B is different than the initial current emotional state expressed by participant B to participant A, the differences between the initial current emotional state of participant B and the second current emotional state of participant B may be intentional or unintentional. The signal of the second current emotional state expressed by participant B to participant A can include an acknowledgement. Further, the signal of the second current emotional state expressed by participant B to participant A can include a counter-response.

In accordance with an exemplary embodiment, an acknowledgement by participant B can include recognition by participant B of participant A's expression of the interpretation and measurement of the observable initial current emotional state of participant B and the amount of uncertainty in participant A's interpretation and measurement of the observable initial current emotional state of participant B. Further, an acknowledgement by participant B can include recognition by participant B of participant A's interpretation and measurement of the observable initial current emotional state of participant B as well as participant A's interpretation and measurement of the amount of uncertainty that is possessed by participant B in participant B's understanding of participant B's observable initial current emotional state as compared to participant B's actual initial current emotional state.

Further, an acknowledgement by participant B can include an amount of agreement by participant B with participant A's expressed interpretation and measurement of the observable initial current emotional state of participant B. As the amount that participant B agrees with participant A's expressed interpretation and measurement of the observable initial current emotional state of participant B increases, the amount of uncertainty that participant B will find in participant A's expressed interpretation and measurement of the observable initial current emotional state of participant B will decrease. As the amount that participant B agrees with participant A's interpretation and measurement of the observable initial current emotional state of participant B decreases, the amount of uncertainty that participant B will find in participant A's expressed interpretation and measurement of the observable initial current emotional state of participant B will increase. The amount by which participant B agrees with participant A's interpretation and measurement of the observable initial current emotional state of participant B, and the amount of uncertainty that participant B finds in participant A's expressed interpretation and measurement of the observable initial current emotional state of participant B, will affect whether the signal of the second current emotional state of participant B includes a counter-response.

It will be understood that participant B may be cognizant that participant B's expression of an observable initial current emotional state of participant B may or may not have, intentionally or unintentionally, reflected the actual initial current emotional state of participant B. Accordingly, participant B's initial expression of input data to participant A, constituting a signal of an observable initial current emotional state of participant B, may or may not have reflected the actual initial current emotional state of participant B insofar as participant B may have been motivated for participant A to achieve a specific interpretation and measurement of the observable initial current emotional state of participant B. In accordance with such an exemplary embodiment, a counter-response by participant B, as part of participant B's signal of an observable second current emotional state, can include expression by participant B to participant A of participant B's understanding of participant B's actual initial current emotional state and the amount of uncertainty that participant B recognizes in participant B's actual initial current emotional state compared to participant B's observable initial current emotional state.

It will be understood that participant B may or may not be cognizant that participant B's expression of an observable initial current emotional state of participant B may have unintentionally and subconsciously or unconsciously varied from an actual initial current emotional state of participant B. Accordingly, even where participant B may not have been motivated for participant A to achieve a specific interpretation and measurement of the observable initial current emotional state of participant B, participant B's initial expression of input data to participant A, constituting a signal of an observable initial current emotional state of participant B, can optionally include some amount of uncertainty in participant B's actual initial current emotional state compared to participant B's observable initial current emotional state by virtue of the discrepancy between participant B's conscious expression and subconscious or unconscious expression. In accordance with such an exemplary embodiment, a counter-response by participant B, as part of participant B's signal of an observable second current emotional state, can include expression by participant B to participant A of participant A's accuracy or the amount of inaccuracy in participant A's interpretation and measurement of participant B's observable initial current emotional state as compared to participant B's understanding of participant B's actual initial current emotional state and the amount of uncertainty that participant B recognizes in participant A's interpretation and measurement of participant B's observable initial current emotional state as compared to participant B's understanding of participant B's actual initial current emotional state.

### 1. D. Participant A's Second Expression of Output Data to Participant B

In an exemplary embodiment, a method according to the present disclosure can further include the process whereby participant A provides output data to participant B in response to the input data regarding the second current emotional state of participant B.

Following participant A's interpretation of the input data transmitted to participant A by participant B and participant A performing a measurement regarding the observable second current emotional state of participant B, participant A can provide output data to participant B constituting a signal expressed by participant A to participant B. The signal provided by participant A to participant B can include an acknowledgement and a counter-response.

In accordance with an exemplary embodiment, an acknowledgement by participant A can include recognition by participant A of what participant B expects will be participant A's interpretation and measurement of the observable second current emotional state of participant B as well as what participant B expects will be the amount of uncertainty in participant A's interpretation and measurement of the observable second current emotional state of participant B. Further, an acknowledgement by participant A can include recognition by participant A of participant B's observable second current emotional state as well as the amount of uncertainty that participant A has ascertained is possessed by participant B in participant B's understanding of participant B's observable second current emotional state as compared to participant B's actual second current emotional state.

In accordance with an exemplary embodiment, a counter-response by participant A can include expression by participant A to participant B of participant A's actual interpretation and measurement of the observable second current emotional state of participant B as well as the actual amount of uncertainty in participant A's interpretation and measurement of the observable second current emotional state of participant B. Further, a counter-response by participant A can include expression by participant A to participant B of participant A's interpretation and measurement of the observable second current emotional state of participant B as well as participant A's interpretation and measurement of the amount of uncertainty that is possessed by participant B in participant B's understanding of participant B's observable second current emotional state as compared to participant B's actual second current emotional state.

### 1. E. Participant B's Subsequent Expression(s) of Input Data to Participant A

In an exemplary embodiment, a method according to the present disclosure can further include the process whereby participant B provides further input data to participant A in response to output data regarding the interpretation and measurement of an observable current emotional state of participant B.

Following participant A providing output data to participant B constituting a signal expressed by participant A to participant B, the signal including, in an exemplary embodiment, an acknowledgement and a counter-response, participant B subsequently can express input data to participant A constituting a signal of a subsequent current emotional state of participant B. A “subsequent current emotional state” can be a third current emotional state, a fourth current emotional state, a fifth current emotional state, a sixth current emotional state, a seventh current emotional state, an eighth current emotional state, a ninth current emotional state, a tenth current emotional state, or any ordinally numbered current emotional state subsequent to the second current emotional state. An “immediately previous current emotional state” is the previous current emotional state to any specific subsequent current emotional state. A subsequent current emotional state can be expressed to participant A by participant B following participant A providing output data to participant B, constituting a signal expressed by participant A to participant B, the signal including, in an exemplary embodiment, an acknowledgement and a counter-response. A subsequent current emotional state of participant B may be a different current emotional state than the immediately previous current emotional state expressed by participant B to participant A, or a subsequent current emotional state of participant B may be the same current emotional state as the immediately previous current emotional state expressed by participant B to participant A. If a subsequent current emotional state of participant B is a different current emotional state than the immediately previous current emotional state expressed by participant B to participant A, the differences between the immediately previous current emotional state of participant B and a subsequent current emotional state of participant B may be conscious, subconscious, or unconscious. Further, if a subsequent current emotional state of participant B is a different current emotional state than the immediately previous current emotional state expressed by participant B to participant A, the differences between the immediately previously current emotional state of participant B and a subsequent current emotional state of participant B may be intentional or unintentional. The signal of a subsequent current emotional state expressed by participant B to participant A can include an acknowledgement. Further, the signal of a subsequent current emotional state expressed by participant B to participant A can include a counter-response.

In accordance with an exemplary embodiment, an acknowledgement by participant B can include recognition by participant B of participant A's expression of the interpretation and measurement of the observable immediately previous current emotional state of participant B and the amount of uncertainty in participant A's interpretation and measurement of the observable immediately previous current emotional state of participant B. Further, an acknowledgement by participant B can include recognition by participant B of participant A's interpretation and measurement of the observable immediately previous current emotional state of participant B as well as participant A's interpretation and measurement of the amount of uncertainty that is possessed by participant B in participant B's understanding of participant B's observable immediately previous current emotional state as compared to participant B's actual immediately previous current emotional state.

Further, an acknowledgement by participant B can include an amount of agreement by participant B with participant A's expressed interpretation and measurement of the observable immediately previous current emotional state of participant B. As the amount that participant B agrees with participant A's expressed interpretation and measurement of the observable immediately previous current emotional state increases, the amount of uncertainty that participant B will find in participant A's expressed interpretation and measurement of the observable immediately previous current emotional state of participant B will decrease. As the amount that participant B agrees with participant A's interpretation and measurement of the observable immediately previous current emotional state of participant B decreases, the amount of uncertainty that participant B will find in participant A's expressed interpretation and measurement of the observable immediately previous current emotional state of participant B will increase. The amount by which participant B agrees with participant A's interpretation and measurement of the observable immediately previous current emotional state of participant B, and the amount of uncertainty that participant B finds in participant A's expressed interpretation and measurement of the observable immediately previous current emotional state of participant B, will affect whether the signal of a subsequent current emotional state of participant B includes a counter-response.

### Example 2

In an exemplary embodiment, a method according to the present disclosure can include the process whereby a participant A (which may be an embodiment of participant 110 or emotional augmentation computer 120 of FIGS. 1 and 2) chooses from a variety of possible responses to a question posed by participant B during a metaphorical call to project a current emotional state that participant A (which may be an embodiment of participant 110 or emotional augmentation computer 120 of FIGS. 1 and 2) wishes to project, even if participant A has no actual current emotional state.

In accordance with such an exemplary embodiment, participant A may be an emotionless software application or similar algorithm that has been engineered to interact with participant B to acquire input data from participant B and provide responses to participant B through a known, common text, interactive voice recognition or facial recognition interface, or the like. Further in accordance with such an exemplary embodiment, participant B may be a human individual who expresses input data, constituting a signal of a current emotional state of participant B, to participant A through conscious, subconscious, and/or unconscious vocal and/or facial cues.

For example, suppose that participant B asks participant A “What is the name of that actor?” Further suppose that participant A has identified five different ways that participant A can respond to participant B's question. Participant A, before responding to participant B, may model participant A's projected emotional state (as observed by participant B) associated with each of the five possible responses. Participant A then chooses the response that has associated with it the emotional state that participant A currently wishes to project to participant B.

For example, suppose that one of the five possible responses will project an emotional state of rudeness from participant A. Projecting an emotional state of rudeness from participant A may result in moving participant B to an emotional state that participant A wishes participant B to have. Conversely, projecting an emotional state of rudeness may be determined by participant A to be contrary to participant A's objectives and the current perceived emotional state of participant B. Therefore, participant A can evaluate the projected emotional state associated with each of the five possible responses, as well as the predicted emotional state of participant B in response thereto, to select a response that will best meet one or more of participant A's objectives.

In some embodiments, participant A may predict several future steps of the interaction between participant A and participant B so that participant A can map out a strategy to get participant B from participant B's current projected emotional state to an emotional state that participant A wishes for participant B to project in as few steps as possible:
(a) Participant A has five possible responses.
(b) Participant A chooses one of the five possible responses and predicts participant B's response.
(i) If participant B responds in the manner predicted by participant A, then participant A will respond with another pre-chosen response.
(ii) If participant B responds in a manner not predicted by participant A (i.e., participant B is projecting an emotional state other than that predicted by participant A), then participant A has already chosen the next response (with its predicted response from participant B).
(iii) The above cycle can continue until participant B ultimately projects the emotional state that participant A wished for participant B to project.

The above process is analogous to a negotiation or to the game of poker (to name just two non-limiting examples)—participant A is signaling an emotional state to get participant B to move in the direction that participant A wants participant B to move. Because participant A can be a software application, participant A can be configured to map out possible scenarios many steps into the future to predict the best sequence of steps to move participant B's projected emotional state to the projected emotional state that participant A wishes participant B to project.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments but should be defined only in accordance with the following claims and their equivalents.

What is claimed is:

1. A computer implemented method for implementing a metaphorical call, comprising:
initiating a call with a participant in communication with a communication module of the computer;
receiving, by a computer, a first communication from the participant, the first communication comprising an emotion attribute comprising information about an emotional characteristic expressed by the participant;
evaluating, by the computer, the emotion attribute expressed by the participant from the first communication;
generating, by the computer, an emotion feedback attribute based on the emotion attribute to elicit a response from the participant;
outputting, by the computer, a second communication comprising the emotional expression attribute.

2. The method of claim 1, wherein the emotional expression attribute comprises one or more of: a satisfaction signal associated with the first communication and a want signal associated with the first signal.

3. The method of claim 1, wherein the evaluating the emotion attribute expressed comprises:
determining, by the computer, a first score associated with a predictive level of certainty associated with the emotion attribute;
determining a second score associated with a price of disengagement, wherein the second score represents a metric of social capital associated with the emotional attribute.

4. The method of claim 1, wherein the generating the emotion feedback attribute comprises determining one or more intended personality traits, the one or more personality traits selected from an active or passive personality trait.

5. The method of claim 1, wherein the generating the emotion feedback attribute comprises:
identifying a first set of emotion spaces associated with an emotion attribute of the participant;
identifying a second set of emotion spaces associated with an emotional expression attribute of the computer.

6. The method of claim 5, wherein the generating the emotion feedback attribute comprises:
identifying a relationship between the first set of emotion spaces and the second set of emotion spaces.

7. The method of claim 1 further comprising:
determining, by the computer, perception information of the participant about an intended satisfaction signal by the computer's emotional expression, wherein the determining is based on the emotional characteristic expressed by the participant.

8. The method of claim 7, wherein the evaluating the emotion attribute comprises identifying a set of emotion spaces associated with the perception information.

9. A system for implementing a metaphorical call, the system comprising:
a computer comprising a memory coupled to a processor, and configured to execute instructions stored in the memory that cause the computer to:
initiate a call with a participant in communication with a communication module of the computer;
receive a first communication from the participant, the first communication comprising an emotion attribute comprising information about an emotional characteristic expressed by the participant;
evaluate the emotion attribute expressed by the participant from the first communication;
generate an emotion feedback attribute based on the emotion attribute to elicit a response from the participant;
output a second communication comprising the emotional expression attribute.

10. The system of claim 9, wherein the emotional expression attribute comprises one or more of: a satisfaction signal associated with the first communication and a want signal associated with the first signal.

11. The system of claim 9, wherein the instructions stored in the memory that cause the computer to:
determine a first score associated with a predictive level of certainty associated with the emotion attribute;
determine a second score associated with a price of disengagement, wherein the second score represents a metric of social capital associated with the emotional attribute.

12. The system of claim 9, wherein the instructions stored in the memory that cause the computer to determine one or more intended personality traits, the one or more personality traits selected from an active or passive personality trait.

13. The system of claim 9, wherein the instructions stored in the memory that cause the computer to:
identify a first set of emotion spaces associated with an emotion attribute of the participant;
identify a second set of emotion spaces associated with an emotional expression attribute of the computer.

14. The system of claim 13, wherein the instructions stored in the memory that cause the computer to identify a relationship between the first set of emotion spaces and the second set of emotion spaces.

15. The system of claim 9 wherein the instructions stored in the memory that cause the computer to determine perception information of the participant about an intended satisfaction signal by the computer's emotional expression, wherein the determining is based on the emotional characteristic expressed by the participant.

16. The system of claim 15 wherein the instructions stored in the memory that cause the computer to identify a set of emotion spaces associated with the perception information.

17. A non-transitory tangible computer-readable device having instructions stored thereon that, when executed by a computer, cause the computer to perform operations comprising:
initiate a call with a participant in communication with a communication module of the computer;
receive a first communication from the participant, the first communication comprising an emotion attribute comprising information about an emotional characteristic expressed by the participant;
evaluate the emotion attribute expressed by the participant from the first communication;
generate an emotion feedback attribute based on the emotion attribute to elicit a response from the participant;
output a second communication comprising the emotional expression attribute.

18. The non-transitory tangible computer-readable device of claim 17, wherein the instructions stored in the memory that cause the computer to:
identify a first set of emotion spaces associated with an emotion attribute of the participant;
identify a second set of emotion spaces associated with an emotional expression attribute of the computer.

19. The non-transitory tangible computer-readable device of claim 18, wherein the instructions stored in the memory that cause the computer to identify a relationship between the first set of emotion spaces and the second set of emotion spaces.

20. The non-transitory tangible computer-readable device of claim 17 wherein the instructions stored in the memory that cause the computer to determine perception information of the participant about an intended satisfaction signal by the computer's emotional expression, wherein the determining is based on the emotional characteristic expressed by the participant.
